(19) United States
(12) Patent Application Publication
(10) Pub. No.: US 2005/0070414 A1
(43) Pub. Date: Mar. 31, 2005

(54) Cushion fold patterns for overhead airbags

(76) Inventors: David W. Schneider, Waterford, MI (US); Timothy A. DePottey, Flint, MI (US)

Correspondence Address: Sally J. Brown;AUTOLIV ASP, INC., 3350 Airport Road, Ogden, UT, 84405, US

(21) Appl. No.: 10/660,086

(22) Filed: Sep. 11, 2003

(51) Int. Cl. B31B 1/26

(52) U.S. Cl. 493/405

(57) ABSTRACT

Folding methods and patterns for folding an inflatable airbag for use in vehicles. The folding patterns and methods of the invention assist in controlling the trajectory of the airbag cushion during deployment. More specifically, the methods and patterns of the invention may be used to deploy an overhead airbag cushion forward and downward along a windshield to place a portion of the airbag cushion rapidly in front of a vehicle occupant before the cushion has the opportunity to inflate significantly in a longitudinal direction to provide support and deceleration to a vehicle occupant. These methods result in airbag deployment which may prevent injury to out-of-position vehicle occupants.

### BACKGROUND OF THE INVENTION

1. Field of the Invention

The present invention relates to methods and patterns for folding airbag cushions. More specifically, the present invention relates to methods and patterns for folding airbag cushions used in overhead-mounted vehicular airbag modules.

2. Description of Related Art

Safety belts are designed to protect the occupants of a vehicle during events such as automobile collisions. In low-speed collisions, the occupants are generally protected from impact with objects located inside the vehicle such as the windshield, the instrument panel, a door, the side windows, or the steering wheel by the action of the safety belt. In more severe collisions, however, even belted occupants may experience an impact with the car's interior. Airbag systems were developed to supplement conventional safety belts by deploying into the space between an occupant and an interior object or surface in the vehicle during a collision event. The airbag acts to decelerate the occupant, thus reducing the chances of injury to the occupant caused by contact with the vehicle's interior.

Many typical airbag systems consist of several individual components joined to form an operational module. Such components generally include an airbag cushion, an airbag inflator, a sensor, and an electronic control unit. Airbag cushions are typically made of a thin, durable fabric that is folded to fit into a compartment of a steering wheel, dashboard, interior compartment, roof, roof rail, roof compartment, or other space in a vehicle. The airbag inflator is in fluid communication with the airbag cushion, and is configured to produce a gas to inflate the cushion when it is needed. The sensors detect sudden decelerations of the vehicle that are characteristic of an impact. The readings taken by the sensors are processed in the electronic control unit using an algorithm to determine whether a collision has occurred.

Upon detection of an impact of sufficient severity, the control unit sends an electrical signal to the inflator. The inflator uses one of many technologies, including pyrotechnic compounds and pressurized gas, to produce a volume of an inflation gas. The inflation gas is channeled into the airbag, inflating it. Inflation of the airbag causes it to deploy, placing it in position to receive the impact of a vehicle occupant. After contact of the occupant with the airbag and the corresponding deceleration of the occupant, the airbag rapidly deflates. To accomplish this, the inflation gas is vented from openings in the airbag, deflating it and freeing the occupant to exit the vehicle.

As experience in the manufacture and use of airbags has increased, the engineering challenges involved in their design, construction, and use have become better understood. Most airbag systems are designed to rapidly inflate and provide a cushion in proximity to a vehicle occupant. Many such cushions are configured to be placed in front of a vehicle occupant. Placement of the cushions is determined based on presumptions made of the position of a vehicle occupant during normal operation of the vehicle. Thus, a vehicle occupant enjoys optimal protection from a specific airbag when the occupant is in the presumed range of positions when the airbag deploys.

In some situations, injuries have occurred when the occupant is “out of position” with regard to the presumed position discussed above. Injuries similar to out of position injuries may also result from improper deployment of the airbag. Improper deployment may result in either poor placement of the cushion when contacted by a vehicle occupant or incursion of the airbag cushion into the space reserved for the vehicle occupant. Such incursion during deployment may raise the probability of injury to the vehicle occupant.

Overhead airbag systems were developed as an alternative to frontally-placed airbag cushions. Such overhead cushions are advantageous in some situations since they deploy into position without exerting a force directly toward the vehicle occupant. In addition, positioning of the primary airbag in the roof of the vehicle when stored allows for greater design flexibility of the steering wheel and/or dashboard components of the vehicle.

One difficulty faced in the design and installation of overhead airbags is controlling the trajectory of deploying overhead airbags. One reason for this is that due to their placement in a vehicle, overhead airbags may encounter sun visors or other roof-mounted accessories during deployment. Such obstacles may deflect or trap an inflating airbag cushion, thus compromising the protection provided to the vehicle occupant. In addition, because overhead airbag cushion modules are generally placed above vehicle occupants in vehicles, their rapid deployment downward into a vehicle cabin may place a vehicle occupant at risk of injury. This risk may be heightened when the vehicle occupant is out of the position anticipated for them in the vehicle by the vehicles' engineers. More specifically, in some situations, if airbags inflate rapidly and fully as they emerge from the roof, they may impinge into space reserved for the head and/or upper body of a vehicle occupant, thus creating a potential for injury.

Accordingly, a need exists for methods of regulating the deployment trajectory of an overhead airbag cushion. More specifically, a need exists for novel folding patterns and methods for use with overhead airbag cushions and modules to improve overhead airbag performance. Such novel folding patterns are provided herein.

### SUMMARY OF THE INVENTION

The apparatus of the present invention has been developed in response to the present state of the art, and in particular, in response to the problems and needs in the art that have not yet been fully solved by currently available airbag folding patterns and methods. Thus, the present invention provides novel methods and patterns for folding inflatable automobile airbag cushions such as overhead airbag cushions.

In accordance with the invention as embodied and broadly described herein in the preferred embodiment, methods and patterns for folding vehicular airbag cushions such as overhead airbag cushions are provided. In one embodiment, the method of the invention comprises the steps of providing an airbag cushion having a cushion throat, a windshield face, an occupant face, first and second lateral sides, and a cushion end; flattening the windshield and occupant faces of the airbag cushion; folding the first and second lateral sides of the airbag cushion inwardly; and contraction folding the airbag cushion from the cushion end toward the cushion throat. The methods of the invention are particularly adapted for use with an overhead airbag cushion.

In the method just described, the step of folding the first and second lateral sides of the airbag inwardly may include flattening them against a face of the airbag cushion. In the methods of the invention the first and second lateral sides of the airbag may be flattened inwardly against either the windshield face of the airbag cushion or the occupant face of the airbag cushion. Indeed, in some folding methods, multiple pairs of lateral sides may be produced, which may be folded against either or both of the faces of the airbag cushion. In some instances, the step of folding the first and second lateral sides of the airbag inwardly may produce an overlap. In addition, in some folding methods of the invention, the step of folding the first and second lateral sides of the airbag cushion inwardly may instead comprise tucking the first and second lateral sides inwardly.

The step of contraction-folding the airbag cushion from the cushion end toward the cushion throat described in the method above may also be widely varied within the scope of the invention. In some of the methods of the invention, this step comprises rolling the airbag cushion from the cushion end toward the cushion throat. Rolling of the airbag cushion from the cushion end toward the cushion throat may be conducted toward the windshield face or the occupant face of the airbag cushion. In other methods of the invention, the step of contraction-folding the airbag cushion from the cushion end toward the cushion throat may comprise accordion-folding the airbag cushion from the cushion end toward the cushion throat.

In other methods according to the invention, the step of contraction-folding the airbag cushion from the cushion end toward the cushion throat comprises accordion-folding a portion of the airbag cushion from the cushion end toward the cushion throat. In such methods, the step of contraction-folding the airbag cushion may be followed by a step of wrap-folding a remaining portion of the airbag cushion from the cushion end toward the cushion throat. This wrap-folding step may be conducted toward the windshield face of the airbag cushion, or alternatively conducted toward the occupant face of the airbag cushion. The additional step of wrap-folding the airbag cushion may also be used in other methods of the invention.

In some of the folding methods of the invention, the airbag cushion to be folded is an overhead airbag cushion having a head region adjacent to a portion of the cushion described as the cushion throat, which is often attached to an airbag inflator. In such methods, the step of folding the first and second lateral sides of the airbag cushion inwardly may be preceded by a step of folding the head region of the airbag cushion inwardly. This step generally involves flattening the head region of the airbag cushion against the occupant face of the airbag cushion.

According to one configuration, the method may comprise the steps of providing an airbag cushion, flattening the airbag cushion, tucking a portion of the airbag cushion inwardly, folding lateral sides of the airbag cushion inwardly to flatten them against the airbag cushion, rolling a portion of the airbag cushion, accordion-folding a portion of the airbag cushion, and wrap-folding the airbag cushion. Airbag cushions used in the methods of the invention are commonly defined as having a cushion throat, a windshield face, an occupant face, first and second lateral sides, and a cushion end. These reference points are useful in describing method steps of specific embodiments of the invention and variations of the methods of the invention existing within its scope.

Thus, in some specific folding methods of the invention, the method of folding an airbag cushion comprises the steps of providing an airbag cushion, the airbag cushion having a cushion throat, a windshield face, an occupant face, first and second lateral sides, and a cushion end; flattening the windshield and occupant faces of the airbag cushion; tucking the cushion end inwardly to form a bottom tuck, and first and second pairs of lateral edges; folding the first and second lateral sides of the airbag cushion to flatten them against a face of the airbag cushion; rolling a portion of the airbag cushion from the cushion end toward the cushion throat; accordion-folding the airbag cushion from the rolled portion toward the cushion throat; and wrap-folding the airbag cushion toward the cushion throat. According to the invention, the airbag cushion may be an overhead airbag cushion.

In the methods of the invention, the step of folding the first and second lateral sides of the airbag to flatten them against a face of the airbag cushion may comprise folding the first and second lateral sides over against the windshield face of the airbag cushion. Alternately, the step of folding the first and second lateral sides of the airbag to flatten them against a face of the airbag cushion may comprise folding the first and second lateral sides against the occupant face of the airbag cushion. Further, this lateral side folding step may be conducted such that it produces an overlap of the first and second lateral sides.

In the methods and patterns of the invention, the portion of the airbag cushion rolled from the cushion end toward the cushion throat may be selected to be a portion of the airbag desired to deploy following the initial deployment and placement of the wrap-folded and accordion-folded portions of the airbag cushion. In addition, the portion of the airbag cushion rolled from the cushion end toward the cushion throat may either be rolled toward the windshield face of the airbag cushion, or rolled toward the occupant face of the airbag cushion.

In addition, according to the methods of the invention, the portion of the airbag cushion folded during the step of accordion-folding the airbag cushion from the rolled portion toward the cushion throat is a portion of the airbag configured to deploy during initial deployment and following unfolding of the wrap-folded portion of the airbag cushion. Within the scope of the invention, the step of accordion-folding the airbag cushion from the rolled portion forward toward the cushion throat may produce from about 0 to about 8 accordion folds, from about 1 to about 4 accordion folds, or about 2 accordion folds. The number and size of accordion folds made in the methods and patterns of the invention may be widely varied by one of ordinary skill in the art. In some of the methods of the invention, no accordion folds are made, and wrap-folds, including overlapping wrap folds, may be substituted in their place.

The step of wrap-folding the airbag cushion toward the cushion throat in the methods and patterns of the invention may comprise folding the airbag cushion about portions of the rolled and accordion-folded sections of the airbag cushion. In various methods, the step of wrap-folding the airbag cushion may comprise folding the airbag cushion about the rolled and accordion-folded portions of the airbag cushion toward the occupant face of the airbag cushion. This may introduce a rearward-directed roll to the airbag cushion upon deployment which will aid its full deployment from an airbag module housing.

Within the scope of the invention, the wrap-fold may encompass the rolled and accordion-folded portions of the airbag cushion in a substantially complete manner. Alternatively, the wrap-fold may encompass only fractional portions of the airbag cushion, with exemplary variations encompassing about ¾ of the rolled and accordion-folded portions of the airbag cushion, about ½ of the rolled and accordion-folded portions of the airbag cushion, or about ¼ of the rolled and accordion-folded portions of the airbag cushion. In some alternate embodiments of the invention, the step of wrap-folding the airbag cushion may comprise folding the airbag cushion about the rolled and accordion-folded portions of the airbag cushion toward the windshield face of the airbag cushion. In still other variations of the invention, the step of wrap-folding the airbag cushion may begin by folding toward the windshield face and subsequently double back upon itself to provide a rearward-directed roll. In still other embodiments of the methods of the invention, the wrap-folding step may be skipped entirely, while in others, additional accordion-folds may be used in place of a wrap-fold.

In some methods of the invention, the geometry of the specific airbag cushion used may render the step of tucking the cushion end inwardly to form a bottom tuck unnecessary. In other instances, the geometry of the specific airbag cushion used may demand the use of multiple tucking steps. In some cases, producing these single or double tucks may produce multiple sets of lateral edges which may be folded inwardly in subsequent steps as groups, or individually.

In some applications, the size of the rolled portion of the airbag cushion may be varied to either increase or decrease the portion of the airbag cushion folded using accordion- and wrap-folding for rapid deployment. In other applications, as briefly discussed above, wrap-folding and accordion-folding may be individually increased or reduced. In still other applications, either wrap-folding or accordion-folding may be omitted.

The patterns and methods of the invention may be specifically useful in overhead airbag applications. Alternatively, however, the patterns and methods of the invention may be useful in other airbag applications including, but not limited to side curtain airbags and vehicle pillar airbags.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a partial perspective view of a vehicle showing an overhead airbag deployed and inflated in front of a vehicle occupant;

FIG. 2A shows an initial flattening step of a method of folding an airbag according to the invention;

FIG. 2B shows the configuration produced by an upward tuck-folding step of a method of folding an airbag according to the invention;

FIG. 2C shows an intermediate folding step of a method of folding an airbag according to the invention;

FIG. 2D shows a rolling step of a method of folding an airbag according to the invention;

FIG. 2E shows a side plan view of the partially-rolled airbag shown in FIG. 2D;

FIG. 3 is a partial perspective view of a vehicle showing an overhead airbag folded according to the invention in process of being deployed and inflated in front of a vehicle occupant;

FIG. 4A shows a side plan view of an airbag cushion folded according to a method of the invention to unfold toward the windshield of the vehicle, the airbag cushion being folded and placed within an airbag module housing and attached to an airbag inflator;

FIG. 4B shows a side plan view of another airbag cushion folded according to an alternate method of the invention to unfold toward a vehicle occupant, the airbag cushion being folded and placed within an airbag module housing and attached to an airbag inflator;

FIG. 4C shows a side plan view of an airbag cushion folded according to still another alternate method of the invention resulting in a folded configuration using accordion-folds, the airbag cushion being folded and placed within an airbag module housing and attached to an airbag inflator;

FIG. 4D shows a side plan view of an airbag cushion folded according to another method of the invention resulting in a folded configuration using accordion-folds, the airbag cushion being folded and placed within an airbag module housing and attached to an airbag inflator;

FIG. 4E shows a side plan view of an airbag cushion folded according to a method of the invention resulting in a folded configuration having accordion folds and roll folds, the airbag cushion being folded and placed within an airbag module housing and attached to an airbag inflator;

FIG. 4F shows a side plan view of another airbag cushion folded according to a method of the invention resulting in a folded configuration having accordion folds and roll folds, the airbag cushion being folded and placed within an airbag module housing and attached to an airbag inflator;

FIG. 4G shows a side plan view of still another airbag cushion folded according to a method of the invention resulting in a folded configuration having accordion folds and roll folds, the airbag cushion being folded and placed within an airbag module housing and attached to an airbag inflator;

FIG. 4H shows a side plan view of an airbag cushion folded according to a method of the invention resulting in a folded configuration having dual sets of roll folds, the airbag cushion being folded and placed within an airbag module housing and attached to an airbag inflator;

FIG. 4I shows a side plan view of an airbag cushion folded according to a method of the invention resulting in a folded configuration having dual sets of inwardly-oriented roll folds, the airbag cushion being folded and placed within an airbag module housing and attached to an airbag inflator;

FIG. 4J shows a side plan view of an airbag cushion folded according to a method of the invention resulting in a folded configuration having dual sets of occupant-facing roll folds, the airbag cushion being folded and placed within an airbag module housing and attached to an airbag inflator;

FIG. 4K shows a side plan view of an airbag cushion folded according to a method of the invention resulting in a folded configuration having dual sets of windshield-oriented roll folds, the airbag cushion being folded and placed within an airbag module housing and attached to an airbag inflator;

FIG. 4L shows a side plan view of an airbag cushion folded according to a method of the invention resulting in a folded configuration having separate accordion and roll folds, the airbag cushion being folded and placed within an airbag module housing and attached to an airbag inflator;

FIG. 4M shows a side plan view of another airbag cushion folded according to a method of the invention resulting in a folded configuration having separate accordion and roll folds, the airbag cushion being folded and placed within an airbag module housing and attached to an airbag inflator;

FIG. 4N shows a side plan view of still another airbag cushion folded according to a method of the invention resulting in a folded configuration having separate accordion and roll folds, the airbag cushion being folded and placed within an airbag module housing and attached to an airbag inflator;

FIG. 4O shows a side plan view of another airbag cushion folded according to a method of the invention resulting in a folded configuration having separate accordion and roll folds, the airbag cushion being folded and placed within an airbag module housing and attached to an airbag inflator;

FIG. 4P shows a side plan view of an airbag cushion folded according to a method of the invention resulting in a folded configuration having dual accordion folds, the airbag cushion being folded and placed within an airbag module housing and attached to an airbag inflator.

FIG. 5A shows an initial flattening step of an alternate embodiment of the methods of folding an airbag according to the invention;

FIG. 5B shows the configuration produced by a side tuck-folding step of an alternate method of folding an airbag according to the invention;

FIG. 5C shows an intermediate folding step of an alternate method of folding an airbag according to the invention;

FIG. 5D shows a side plan view of the partially-folded airbag shown in FIG. 5C;

FIG. 5E shows a side plan view of the partially-folded airbag shown in FIG. 5C which has been partially rolled from the cushion end toward the head region of the cushion;

FIG. 5F shows an airbag cushion shown fully folded according to an alternate method of folding of the invention;

FIG. 6A shows a side plan view of an airbag cushion with a head region folded according to a method of the invention, the airbag cushion being folded and placed within an airbag module housing and attached to an airbag inflator;

FIG. 6B shows a side plan view of an airbag cushion with a head region folded according to a method of the invention resulting in a folded configuration having an occupant-oriented roll fold, the airbag cushion being folded and placed within an airbag module housing and attached to an airbag inflator;

FIG. 6C shows a side plan view of an airbag cushion having a head portion folded according to a method of the invention resulting in a folded configuration having an accordion fold, the airbag cushion being folded and placed within an airbag module housing and attached to an airbag inflator;

FIG. 6D shows a side plan view of another airbag cushion having a head portion folded according to a method of the invention resulting in a folded configuration having an accordion fold, the airbag cushion being folded and placed within an airbag module housing and attached to an airbag inflator;

FIG. 6E shows a side plan view of another airbag cushion having a head portion folded according to a method of the invention resulting in a folded configuration having a windshield-oriented roll fold, the airbag cushion being folded and placed within an airbag module housing and attached to an airbag inflator;

FIG. 6F shows a side plan view of an airbag cushion having a head portion folded according to a method of the invention resulting in a folded configuration having an occupant-oriented roll fold and a windshield-oriented roll fold, the airbag cushion being folded and placed within an airbag module housing and attached to an airbag inflator;

### DETAILED DESCRIPTION OF THE PREFERRED EMBODIMENTS

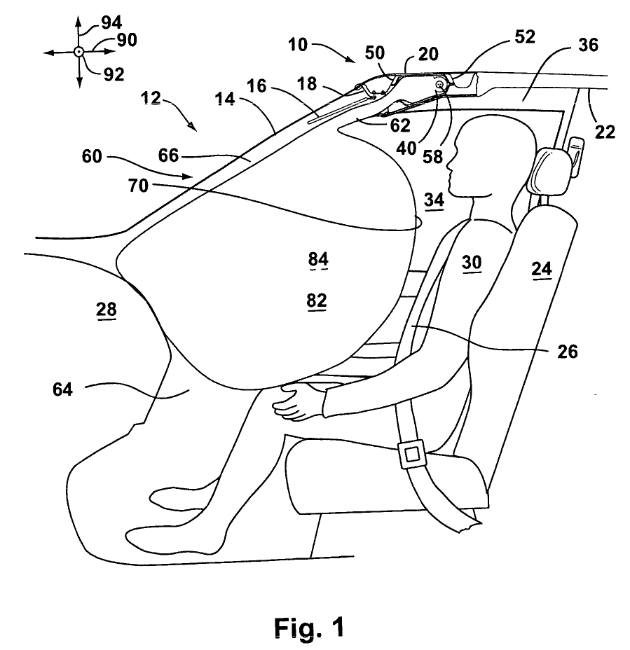

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 6E, is not intended to limit the scope of the invention, as claimed, but is merely representative of presently preferred embodiments of the invention.

The production of airbag systems capable of being stowed and deployed from the roof of a vehicle provides additional flexibility to vehicle designers and gives safety engineers another option for protecting vehicle occupants in specific vehicle designs. Although innovative and effective, overhead airbag systems also face difficulties in their design and implementation.

A first difficulty presented by currently used overhead airbag systems is proper deployment of the airbag from its housing in the roof of a vehicle. Some known overhead airbag systems suffer from diminished function in that their airbag cushions may become lodged in their housings during deployment. As a result, the airbag cushion may deploy in a skewed or incomplete manner. In addition, because overhead airbag cushions deploy from the roof, common interior vehicle accessories such as rear-view mirrors and sun visors may be positioned in the path of the deploying airbags. Such obstacles may also impede proper positioning and deployment of the cushion and potentially compromise the protection desired to be provided to the vehicle occupant.

In addition to the above, because overhead airbag modules are often positioned substantially above a vehicle occupant in a vehicle, their trajectory must be carefully tuned to prevent entry of the airbag cushion into space reserved for the vehicle occupant. This assures that when the vehicle occupant is properly positioned within the vehicle when the airbag cushion is deployed, the airbag cushion may inflate without contacting the occupant.

In addition, in some collision events, the vehicle occupant may be in a position not anticipated by safety engineers. Such occupants may be subject to a higher risk of injury by a deploying airbag because of their improper placement. In the case of overhead airbags, some out-of-position injuries to occupants may occur when a cushion expands too rapidly during deployment as it exits the airbag module housing. In such events, the airbag cushion may still be near the area reserved for a vehicle occupant's head or upper body when it begins to longitudinally expand. This early expansion in close proximity to the occupant may raise the potential for injury.

The airbag folding patterns and methods of the invention help to provide a degree of control over the trajectory of a deploying overhead airbag. More specifically, the folding patterns of the invention generally help to assure complete exit of a folded airbag cushion from an airbag module housing, assist the airbag cushion in deploying rapidly forward and down along the contour of the windshield prior to significant longitudinal cushion expansion, and then allow complete and rapid inflation of the properly-positioned airbag cushion to support and decelerate a vehicle occupant during a collision event.

Referring first to FIG. 1, a partial perspective view of a vehicle 12 is shown. In FIG. 1, an overhead airbag module 10 is shown installed in a vehicle, with the overhead airbag cushion 60 deployed and inflated in front of a vehicle occupant 30. The vehicle 12 includes a dashboard 28 and windshield 14 positioned in front of the vehicle occupant 30. The vehicle occupant 30 is further encompassed in a lateral direction 92 by a door 36 and side window 34, and is shown seated on a vehicle seat 24 and restrained by a seatbelt 26.

The vehicle 12 is further shown to include an overhead airbag module 10 mounted in the roof 20 of the vehicle 12 substantially above the vehicle occupant 30 in a transverse direction 94. The airbag module 10 is shown to include an airbag module housing 40 attached to the vehicle roof 20 by front and rear housing mounts 50, 52. The airbag module 10 may further be enclosed by headliner trim 22, often for cosmetic purposes. The airbag module 10 may include an airbag inflator 58 attached to an overhead airbag cushion 60 in such a manner that inflation gas produced by the inflator 58 may pass freely into the airbag cushion 60 to drive its deployment from the airbag module housing 40. When the inflator 58 is activated, it produces inflation gas, causing the airbag cushion 60 to deploy from the housing 40 in the roof 20 outward into the interior of the vehicle 12 into a space between the vehicle occupant 30 and other surface features of the vehicle 12 such as the dashboard 28 and windshield 14.

The overhead airbag cushion 60 is an inflatable cushion configured to receive inflation gas from the airbag inflator 58. The overhead airbag cushion 60 is configured to be positioned substantially above a vehicle occupant 30 in a transverse direction 94 within a roof 20 of a vehicle 12. During a collision event, the overhead airbag module 10 is configured to place an inflated airbag cushion 60 rapidly and reliably in front of a vehicle occupant 30. The airbag cushion 60 may be stored in an airbag module housing 40 which may be attached to the roof 20 of the vehicle 12 by front and rear mounts 50, 52. In some airbag modules 10, an airbag inflator 58, connected to the airbag cushion 60 may also be contained within the housing 40. During normal operation of the vehicle 12, the airbag module 10 may be largely obscured by headliner trim 22, which may be at least partially displaced upon deployment of the airbag cushion 60.

The airbag cushion 60 may be mounted to the vehicle 12 and airbag inflator 58 at a region of the cushion 60 referred to as the cushion throat 62. The length, shape, and configuration of the cushion throat 62 may be adapted to render the airbag cushion 60 suitable for use with various suitable airbag inflators and securing apparatus, as well as to render its use suitable in a wide variety of vehicles. The design of the cushion throat 62, and indeed, of the cushion 60 itself may be varied to allow use in either the passenger's side of a vehicle 12 or the driver's side of a vehicle 12. Such adaptations and modifications are known to one of ordinary skill in the art.

The airbag cushion 60 has a windshield face 66, an occupant face 70, an inboard cushion face 82, and an outboard cushion face 84. When deployed, the windshield face 66 of the cushion 60 faces the windshield 14 of the vehicle, while the occupant face 70 is deployed before the vehicle occupant 30 such that as the occupant 30 travels forward through the vehicle 12 during a collision event, the occupant 30 contacts the occupant face 70 of the cushion 60, which decelerates the occupant 30. The airbag cushion 60 further includes inboard and outboard faces 82 and 84, which face the cabin and sidewalls of the vehicle 12, respectively.

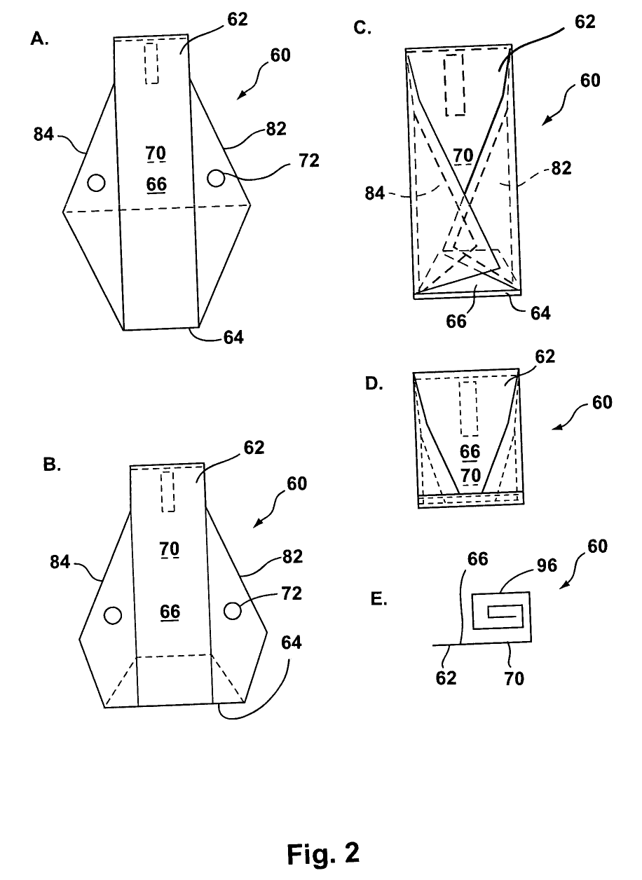

Referring now to FIGS. 2A-2E, the steps of an exemplary method of folding an airbag cushion according to the folding patterns of the invention are shown. Referring first to FIG. 2A, an airbag 60 is shown with the windshield face 66 and the occupant face 70 flattened in a first step of the folding patterns and methods of the invention. The cushion throat 62 is shown oriented at the top of FIG. 2A, while the cushion end 64 is shown at the bottom of FIG. 2A. The airbag cushion 60 may have vents 72 placed on surfaces of the airbag 60 to allow escape of the inflation fluid prior to use of the airbag cushion 60.

According to folding methods of the invention, the airbag cushion 60 may next either proceed to the folding steps illustrated in FIGS. 2C through 2E, or it may undergo an intermediate step shown in FIG. 2B in which be the cushion 60 is tuck-folded from the cushion end 64 inwardly toward the cushion throat 62. In some cases, the bottom tuck-folding step is useful where the airbag cushion 60 is large or long. In some variations of the folding methods of the invention, the bottom tuck-folding step may be repeated multiple times. Producing such tuck-folds may additionally produce multiple sets of lateral edges such as inboard and outboard edges 82, 84 shown in FIGS. 2B-2C. In circumstances where multiple lateral edges are produced, the steps shown in FIGS. 2B and 2C may be repeated as necessary. Thus, these lateral edges may be folded inwardly either individually or all at once within the scope of the invention. In addition, the lateral edges may be overlapped when folded. Such overlapping may be useful when the width of the folded airbag 60 must be adjusted to fit the space available for an airbag module in a particular vehicle. One of skill in the art would understand that the folding patterns of the invention may be easily adapted to accommodate other airbag cushions in which tuck-folding is unnecessary.

Referring next to FIG. 2C, the airbag cushion 60 of FIG. 2B is shown. In this Figure, the inboard 82 and outboard 84 edges of the airbag cushion 60 are shown to be folded inwardly. More specifically, the inboard and outboard edges 82, 84 of the windshield face 66 of the airbag cushion 60 are shown to have been folded inwardly and flattened against the windshield face 66 of the airbag cushion 60. The edges 82, 84 may be folded such that they overlap each other. In folding patterns and methods in which there are bottom tucks, both the occupant face and the windshield face each include a pair of inboard and outboard edges 82, 84. This may change dependent on the geometry of the particular airbag being folded, as is understood by one of skill in the art. In airbag cushions not receiving bottom tucks, there may be only single inboard and outboard edges 82, 84, which could either then receive a lateral tuck if width considerations merited, or which could simply be folded inward before proceeding to the remaining folding steps. As shown in FIG. 2C, each member of the pairs of inboard and outboard edges 82, 84 of the airbag cushion 60 may be folded over individually, or they may be folded over as a group. As shown, in order to accommodate the folded airbag cushion 60 within a housing of a vehicle, the inboard and outboard edges 82, 84 may be overlapped to provide a narrower configuration.

In the folding step illustrated in FIG. 2C, the inboard and outboard edges 82, 84 are shown folded against the windshield face 66 of the airbag cushion 60. In other variations of the folding methods of the invention, the airbag cushion 60 may be oriented such that the occupant face 70 of the airbag is oriented upward. In such folding methods, the lateral edges such as the inboard and outboard edges 82, 84 may be folded inwardly against the occupant face of the airbag cushion 60. The fold orientation may be varied within the scope of the invention, and in some cases, such as those with multiple sets of lateral edges, it may be advantageous to have lateral edges folded toward each face 66, 70 of the airbag cushion 60. As illustrated in FIG. 2C, the airbag cushion 60 is shown to have the pairs of inboard and outboard edges 82, 84 completely folded inward to impart a narrow, elongated form to the partially-folded airbag cushion 60. As discussed briefly above and illustrated in FIG. 2C, the pairs of inboard and outboard edges 82, 84 may be overlapped to regulate the width of the partially-folded airbag cushion 60.

FIGS. 2D and 2E show an example of a set of secondary steps of the folding methods and patterns of the invention. These secondary steps all generally condense the elongated narrow form produced by the initial folding steps to render the airbag cushion 60 suitable for placement in an airbag module such as 10 of FIG. 1. In addition, the types, order, proportions, and other characteristics of various folds used in these secondary steps may affect the trajectory of the airbag cushion 60 during deployment.

The steps taken in this set of secondary folding steps may be broadly referred to as contraction-folding, and may take many forms within the scope of the invention. Contraction folding is used to draw the cushion end 64 toward the cushion throat 62 to aid in fitting an airbag cushion 60 into a housing of an airbag module. In some of the methods of the invention, this contraction-folding includes rolling the airbag cushion 60 from the cushion end 64 toward the cushion throat 62. Rolling of the airbag cushion 60 from the cushion end 64 toward the cushion throat 62 may be conducted toward the windshield face 66 or the occupant face 70 of the airbag cushion 60. In other methods of the invention, the step of contraction-folding the airbag cushion 60 from the cushion end 64 toward the cushion throat 62 may comprise accordion-folding the airbag cushion 60 from the cushion end 62 toward the cushion throat 64. Contraction-folding may include the use of combinations of accordion- and roll-folding in preparing a single airbag cushion 60, as well as the use of circumstances where a given cushion 60 has multiple cushion ends 64 which are contraction-folded in different ways toward the cushion throat 62. Contraction folding may additionally be conducted by producing random folds using methods commonly known in the art.

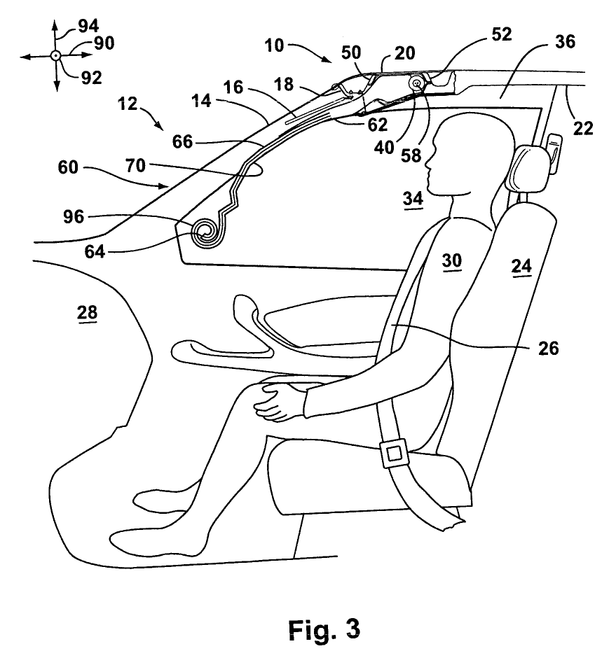

In FIG. 2D, the airbag cushion 60 of FIG. 2C has been partially rolled, beginning at the cushion end 64 (or in this case the cushion end 64 produced after the cushion received the bottom tuck folds), and proceeding toward the cushion throat 62. FIG. 2E is a side plan view of the folded and secondarily roll-folded airbag cushion 60 of FIG. 2D, showing that a portion of the cushion 60 has been rolled toward the windshield face 66 of the airbag cushion 60. It should be noted that the size of the roll-folded portion 96 of the cushion 60 may be varied within the scope of the invention to help control the deployment trajectory of the cushion 60, as will be discussed in connection with FIG. 3 below. In addition, the orientation of the roll fold 96 (i.e., toward the windshield face 66 of the cushion 60 or toward the occupant face 70 of the cushion 60) may be varied within the scope of the invention. Having been roll-folded, the airbag cushion 60 is prepared to be mounted in an airbag module housing such as 40 shown in FIG. 1.

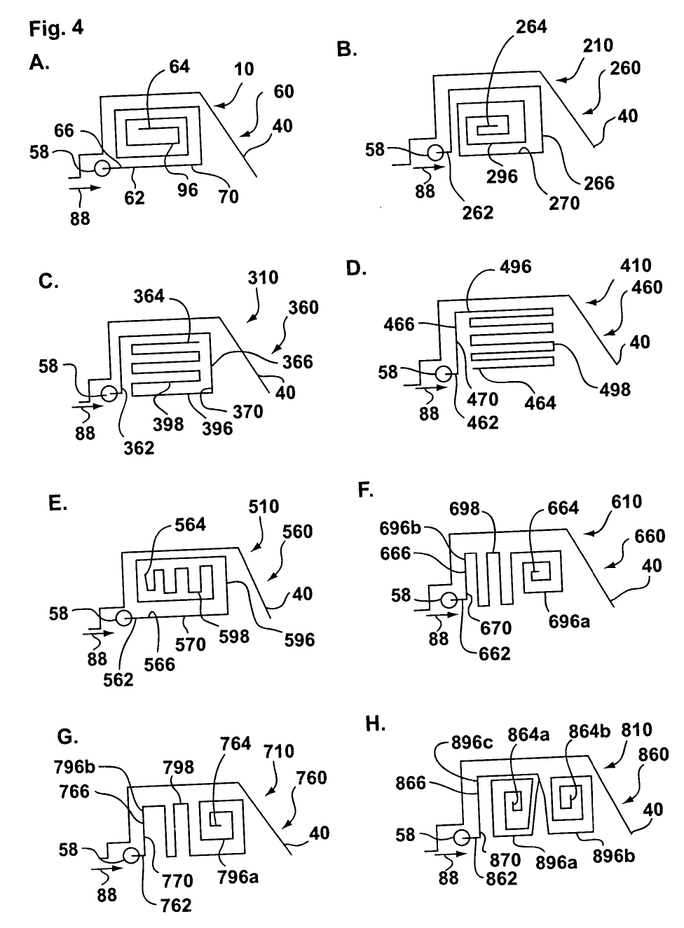

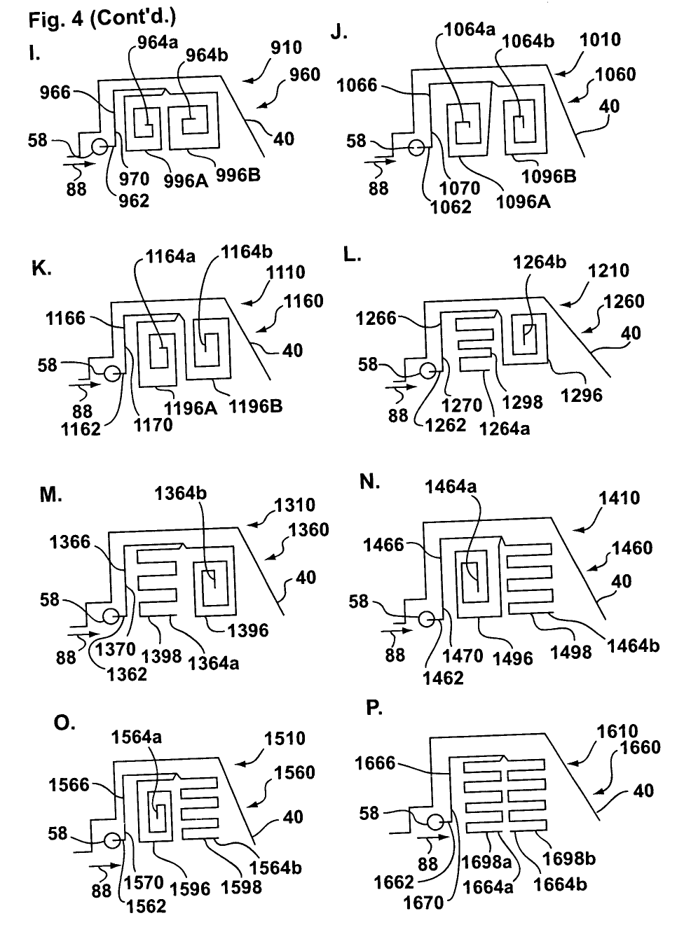

Referring now to FIG. 3, an airbag module 10 (shown in detail in FIG. 4A) is shown mounted in a vehicle 12 and partially deployed. The airbag module 10 comprises an airbag cushion 60 folded as illustrated in FIGS. 2A-2E, an airbag inflator 58, and airbag module housing 40. The airbag module 10 is shown to be mounted in a roof portion 20 of the vehicle 12. In some mounting schemes, front and rear housing mounts 50, 52 may be used to properly retain the airbag module housing 40 in the roof 20 of the vehicle 12. A roof trim or headliner 22 may then be used to obscure the module 10 from view during normal operation of the vehicle 12. The roof trim 22 may then be displaced by the deploying airbag cushion 60, as illustrated in FIG. 3, as the cushion 60 expands.

To deploy the airbag 60, the inflator 58 produces a jet of gas (not shown) which begins to fill the cushion 60, causing it to expand and unfold, thus driving it from the housing 40. As the airbag cushion 60 deploys, the direction in which roll-fold 96 was made imparts a forward roll to the ejecting cushion 60. In FIG. 3, the roll-fold 96 is shown to have partially unfolded. Because the roll-folded portion 96 of the cushion 60 unrolls rapidly, the gas jet (not shown) produced by the inflator 58 will generally direct the airbag cushion 60 forward and downward in the vehicle 12 as it deploys along the windshield 14.

In addition, because the roll-folded portion 96 unrolls rapidly, this forward positioning of the cushion 60 along the windshield 14 occurs before the airbag cushion 60 has begun to expand significantly toward the vehicle occupant 30, here shown positioned in a front seat 24. As the inflation gases advance toward the cushion end 64 of the airbag cushion 60 found near the center of the roll-folded portion 96, the airbag cushion 60 begins to expand in a longitudinal direction 90, resulting in the advance of the airbag cushion 60 toward the occupant 30. In some instances, this expansion in a longitudinal direction 90 may be caused by greater resistance to expansion provided by the rolled region 96 of the cushion 60. Such resistance to expansion may be calibrated by the tightness of the roll fold 96 imparted to the airbag cushion 60. This may aid proper inflation of the cushion 60, however, by triggering longitudinal expansion of the cushion 60 before the vehicle occupant has traveled too far forward in the vehicle 12 to allow proper deceleration prior to full inflation of the cushion 60.

The folding patterns and methods of the invention may provide rapid positioning of an airbag cushion 60 in front of a vehicle occupant 30 before the cushion has expanded significantly in a longitudinal direction 90. The folding patterns and methods of the invention may additionally trigger longitudinal expansion before complete unfolding of the cushion 60 to assure timely placement of the inflated cushion 60 in the path of the vehicle occupant 30. These folding methods and patterns thus reduce the likelihood of injury to a vehicle occupant 30 resulting from early expansion of the cushion 60 toward the occupant 30. The folding methods and patterns may additionally reduce the likelihood of injury to a vehicle occupant 30 resulting from circumstances in which the occupant 30 has traveled so far forward in a vehicle 12 during initial deployment of the airbag cushion 60 to be properly decelerated.

Referring next to FIGS. 4A-4P, a variety of exemplary embodiments of the folding patterns of the invention is shown. Each embodiment is depicted by providing a side plan view of an airbag module with a module housing, airbag inflator, and airbag cushion. These Figures show a plan view of the folding pattern imparted during the secondary folding steps used to compact the narrowed, elongated cushion fold produced in the folding steps illustrated in FIGS. 2A-2C. It would be understood by one of skill in the art that these examples depict only a few potential variations of the folding patterns of the invention. In these exemplary variations, characteristics such as the orientation of the cushion, the direction of the folds, and the number of the folds have been varied. For the purposes of these exemplary folding patterns, the initial folding steps, as illustrated in FIGS. 2A through 2C and discussed in detail above, have been omitted, and only the final plan view has been provided. The plan views provided illustrate wide variations possible in the rolling, accordion-folding, and wrapping steps of the folding methods and patterns of the invention. One of ordinary skill in the art would be able to discern additional patterns within the scope of the invention based upon this disclosure.

In a first such example, FIG. 4A shows the airbag module 10 illustrated in FIG. 3. As in FIG. 3, airbag module 10 includes a module housing 40, an inflator 58, and an airbag cushion 60 folded according to a method and pattern of the invention. As noted above, the cushion 60 has previously been prepared as discussed and illustrated in connection with FIGS. 2A through 2D, above. Following this, the cushion 60 was rolled from the cushion end 64 toward the cushion throat 62. In the method illustrated in FIGS. 3 and 4A, the airbag cushion 60 is roll-fold 96 is oriented to unfold toward the occupant face 70 of the airbag cushion 60. This allows the rolled portion 96 of the airbag cushion 60 to unroll away from the occupant of a vehicle during deployment of the airbag cushion 60 in a vehicle.

In a next example, FIG. 4B shows an airbag module 210 having a module housing 40 and an inflator 58, the module 210 further including an airbag cushion 260 folded according to a method and pattern of the invention. As noted above, the cushion 260 has previously been prepared as discussed and illustrated in connection with FIGS. 2A through 2C, above. Following this, the cushion 260 was rolled from the cushion end 264 toward the cushion throat 262. In this example, however, the roll-fold 296 produced is oriented toward the occupant face 270 of the airbag cushion 260 instead of toward the windshield face 266 of the cushion 260. As a result of this modification, as the airbag cushion 260 is projected forward through a vehicle and downward along a windshield, the airbag cushion 260 unrolls toward the vehicle occupant.

In addition to the fact that the airbag cushion 260 unrolls toward the occupant, the occupant-face-oriented roll fold 264 may impart an additional property to the deploying airbag cushion 260 and other cushions having similar folds. More specifically, as a gas jet (not shown) traveling in a direction 88 out of the airbag inflator 58 enters the airbag cushion 260, it is forced upward deeper into the housing 40 of the module 10. The gas jet then travels forward along a top portion of the roll fold 296 of the cushion 260, causing portions of the cushion 260 deepest in the housing 40 to expand. This forces the remainder of the roll-folded portion 296 of the cushion 260 to deploy from the module 210, and helps to assure proper and complete deployment of the cushion. In addition to mechanically forcing the airbag cushion 260 out of the housing 40, this occupant-oriented, or “rearward roll” sets the body of the cushion 260 in rotation as it travels downward and forward, further aiding in the deployment of the cushion 260. Folding patterns of the invention may utilize this feature, referred to herein as a rearward roll, to varying degrees to assist in airbag deployment. Other folding patterns of the invention include alternate features to assist in the deployment of the airbag cushion from its housing.

Referring next to FIG. 4C, an airbag module 310 with a module housing 40, an inflator 58, and an airbag cushion 360 folded according to an alternative method and pattern of the invention are shown. As noted above, the cushion 360 was prepared as discussed and illustrated in connection with FIGS. 2A through 2C. Following this, the cushion 360 received secondary folds, beginning with several accordion folds 398. More specifically, the airbag cushion 360 was accordion-folded from the cushion end 364 toward the cushion throat 362. Accordion folds 398 may deploy in a rapid manner without a directional rolling motion. Use of accordion folds 398 may be warranted in circumstances where rapid forward deployment of the airbag cushion 360 is needed to position the airbag cushion 360 in front of a vehicle occupant. The number, size, and configuration of the accordion folds of the patterns and methods of the invention may be varied widely, as known to one of skill in the art.

In this example of the folding methods and patterns of the invention, the airbag cushion 360 underwent further secondary folding after the accordion folds 398 were produced. Specifically, in this method, following the initial production of the accordion folds 398, a remaining portion of the airbag cushion 360 was rolled from the accordion folds 398 toward the cushion throat 362. As in FIG. 4B, the roll-fold 396 produced is oriented toward the occupant face 370 of the airbag cushion 360 instead of toward the windshield face 366 of the cushion 360. In the folding pattern and method illustrated in FIG. 4C, a complete rearward roll is used. One of skill in the art will understand that the amount of rolling used in the methods of the invention may be varied widely.

In one specific example of this, a somewhat similar folding pattern and method are illustrated in FIG. 4D. In FIG. 4D, an airbag module 410 is shown. As above, the module 410 has a module housing 40, an inflator 58, and an airbag cushion 460 folded according to a method and pattern of the invention. As noted above, the cushion 460 has previously been prepared as discussed and illustrated in connection with FIGS. 2A through 2C, above. As in FIG. 2C, this pattern and method similarly uses an initial set of accordion folds 498, and is then completed with a partial roll fold 496. The roll fold 496, in this instance, however, is only partial in that it only surrounds a portion of the accordion-folded region 498 of the cushion 460. The cushion 460 was rolled from the cushion end 464 toward the cushion throat 462. The roll-fold 496 produced is oriented toward the occupant face 470 and away from the windshield face 466 of the airbag cushion 460, and thus provides the rearward roll discussed above during deployment to assist in fully deploying the airbag cushion 460 from the housing 40. Other fractional roll-folds may be used within the scope of the invention.

Referring next to FIG. 4E, still another airbag module 510 is shown. As above, the module 510 has a module housing 40, an inflator 58, and an airbag cushion 560 folded according to a method and pattern of the invention. The airbag cushion 560 includes a cushion throat 562, a cushion end 564, a windshield face 566, and an occupant face 570. Further, the cushion 560 has previously been prepared as discussed and illustrated above in connection with FIGS. 2A through 2C. The cushion 560 was next accordion-folded from the cushion end 564 toward the cushion throat 562, producing accordion folds 598. As in several of the previous examples discussed above, the accordion-fold 598 produced is next roll-folded, in this case, producing a 1¼ roll fold 596. In this instance, the roll-fold produced is oriented toward the windshield face 566 of the airbag cushion 560 instead of toward the occupant face 570 of the cushion 560. A folding pattern such as that illustrated in FIG. 4E, having a longer roll-folded region 596 provides an alternative folding pattern which may be useful in longer airbag cushions. In addition, such elongated rolled portions may be desirable in situations in which an extended portion of the cushion 560 (including substantially just the roll-folded region 596) is desired to deploy before the cushion 560 begins to expand longitudinally within the cabin of the vehicle toward the vehicle occupant (not shown).

In FIG. 4F, still another airbag module 610 is shown. The module 610 has a module housing 40, an inflator 58, and an airbag cushion 660 folded according to a method and pattern of the invention. The airbag cushion 660 includes a cushion throat 662, a cushion end 664, a windshield face 666, and an occupant face 670. Further, the cushion 660 has previously been prepared as discussed and illustrated above in connection with FIGS. 2A through 2C. This cushion 660 has been folded by initially being rolled beginning at the cushion end 664 toward the cushion throat 662. The roll fold 696a produced is oriented toward the occupant face 670 of the cushion 660. Following this, the cushion 660 underwent additional secondary folding to produce a series of accordion folds 698. The accordion-folds 698 terminate at the inflator 58 in such a fashion that the gas jet (not shown) produced by the inflator 58 is redirected from its original direction 88 up into the inflator housing 40. As with the methods and patterns illustrated in FIGS. 4C-4E, above, this produces a rearward roll to force the airbag cushion 660 out of the housing 40. Indeed, the final fold of the accordion folds 698 descending toward the inflator 58 may be alternatively described as a partial roll-fold 696b.

Referring next to FIG. 4G, still another airbag module 710 is shown. The module 710 has a module housing 40, an inflator 58, and an airbag cushion 760 folded according to a method and pattern of the invention. The airbag cushion 760 includes a cushion throat 762, a cushion end 764, a windshield face 766, and an occupant face 770. Further, the cushion 760 has previously been prepared as discussed and illustrated above in connection with FIGS. 2A through 2C. As in FIG. 4F, the cushion 760 was first rolled from the cushion end 764 toward the cushion throat 762. As in several of the previous examples, the roll-fold 796a produced is oriented toward the windshield face 766 of the airbag cushion 760. The airbag cushion 760 next received two accordion folds 798, before terminating at the cushion throat 762 at the airbag inflator 58. As in FIG. 4F, the accordion-folds 798 terminate at the inflator 58 in such a fashion that the gas jet (not shown) produced by the inflator 58 is redirected from its original direction 88 up into the inflator housing 40. As with the methods and patterns illustrated in FIGS. 4C-4E 1 and 4F, this produces a rearward roll to force the airbag cushion 760 out of the housing 40. Indeed, the final fold of the accordion fold 798 descending toward the inflator 58 may alternatively be described as a partial roll-fold 796b. This folding pattern is thus similar to that of FIG. 4F, with the exception that the rolled portion 796a of FIG. 4G is oriented such that it will unroll toward the windshield when mounted in a vehicle and deployed.

Referring next to FIGS. 4H-4P, the airbag cushion shown is prepared as shown and discussed in connection with FIGS. 2A-2C, as above, with the exception that the tucking step shown in FIG. 2B was performed to such an extent that two cushion ends were produced. Each cushion end may be folded independently. In FIGS. 4H-4P, various folding patterns and methods are illustrated in which multiple cushion ends are folded independently from each other to provide differing deployment characteristics to portions of the airbag cushion such as the cushion end nearest the vehicle occupant and the cushion end nearest the windshield.

Referring first to FIG. 4H, an airbag module 810 is shown. The module 810 has a module housing 40, an inflator 58, and an airbag cushion 860 folded according to a method and pattern of the invention. The airbag cushion 860 includes a cushion throat 862, a windshield face 866, an occupant face 870, and first and second cushion ends 864a, 864b. The cushion 860 was initially folded and prepared as discussed and illustrated above in connection with FIGS. 2A through 2C. In this method, however, the cushion 860 underwent the tucking step shown in FIG. 2B to such an extent that two cushion ends 864a, 864b were produced. Each cushion end 864a, 864b may then be folded independently in the secondary folding steps of the invention. Such independent folding may impart differing deployment characteristics to the portion of the cushion nearest the vehicle occupant (generally end 864a) and nearest the windshield (generally end 864b).

In the folding method and pattern illustrated in FIG. 4H, the cushion ends 864a, 864b are each folded independently. The first cushion end 864a is positioned nearest the vehicle occupant. In this method, the first cushion end 864a is rolled toward the cushion throat 862 oriented toward the occupant face 870 of the airbag cushion 860 to produce a first roll fold 896a. Further, the second cushion end 864b is rolled toward the cushion throat 862 oriented toward the windshield face 866 of the airbag cushion 860 to produce a second roll fold 896b. As a result, when the airbag cushion 860 deploys, the first cushion end 864a unrolls toward the vehicle occupant, and the second cushion end 864b unrolls toward the windshield. A folding pattern such as that illustrated in FIG. 4H having dual roll-folds 896a, 896b may be useful in larger airbag cushions 860 in which a substantial bottom tuck fold is needed to shorten the cushion 860.

Referring next to FIG. 4I, an airbag module 910 is shown. The module 910 has a module housing 40, an inflator 58, and an airbag cushion 960 folded according to a method and pattern of the invention. The airbag cushion 960 includes a cushion throat 962, a windshield face 966, an occupant face 970, and first and second cushion ends 964a, 964b. The cushion 960 was initially folded and prepared as discussed and illustrated above in connection with FIGS. 2A through 2C. In this method, however, the cushion 960 underwent the tucking step shown in FIG. 2B to such an extent that two cushion ends 964a, 964b were produced. In the folding method and pattern illustrated in FIG. 4I, the cushion ends 964a, 964b are each folded independently. In this method, the first cushion end 964a is rolled toward the cushion throat 962 oriented toward the windshield face 966 of the airbag cushion 960 to produce a first roll fold 996a. Further, the second cushion end 964b is rolled toward the cushion throat 962 oriented toward the occupant face 970 of the airbag cushion 960 to produce a second roll fold 996b.

As a result of this folding method, when the airbag cushion 960 deploys, the first cushion end 964a unrolls toward the windshield, and the second cushion end 964b unrolls toward the vehicle occupant. As with the pattern shown in FIG. 4H above, this folding pattern having dual roll-folds 996a, 996b may be useful in larger airbag cushions 960 in which a substantial bottom tuck fold is needed to shorten the cushion 960. In addition, this folding pattern may be useful since the unrolling roll folds 996a, 996b are directed toward each other, thus providing a neutral forward and downward trajectory.

Referring next to FIG. 4J, an airbag module 1010 is shown. The module 1010 has a module housing 40, an inflator 58, and an airbag cushion 1060 folded according to a method and pattern of the invention. The airbag cushion 1060 includes a cushion throat 1062, a windshield face 1066, an occupant face 1070, and first and second cushion ends 1064a, 1064b. The cushion 1060 was initially folded and prepared as discussed and illustrated above in connection with FIGS. 2A through 2C. In this method, however, the cushion 1060 underwent the tucking step shown in FIG. 2B to such an extent that two cushion ends 1064a, 1064b were produced. In the folding method and pattern illustrated in FIG. 4J, the cushion ends 1064a, 1064b are each folded independently. In this method, the first cushion end 1064a is rolled toward the cushion throat 1062 oriented toward the occupant face 1066 of the airbag cushion 1060 to produce a first roll fold 1096a. Further, the second cushion end 1064b is also rolled toward the cushion throat 1062 oriented toward the occupant face 1070 of the airbag cushion 1060 to produce a second roll fold 1096b.

As a result of this folding method, when the airbag cushion 1060 deploys, both cushion ends 1064a, 1064b unroll toward the vehicle occupant. As with the pattern shown in FIGS. 4H and 4I above, this folding pattern having dual roll-folds 1096a, 1096b may be useful in larger airbag cushions 1060 in which a substantial bottom tuck fold is needed to shorten the cushion 1060.

Referring next to FIG. 4K, an airbag module 1110 is shown. The module 1110 has a module housing 40, an inflator 58, and an airbag cushion 1160 folded according to a method and pattern of the invention. The airbag cushion 1160 includes a cushion throat 1162, a windshield face 1166, an occupant face 1170, and first and second cushion ends 1164a, 1164b. The cushion 1160 was initially folded and prepared as discussed and illustrated above in connection with FIGS. 2A through 2C. In this method, however, the cushion 1160 underwent the tucking step shown in FIG. 2B to such an extent that two cushion ends 1164a, 1164b were produced. In the folding method and pattern illustrated in FIG. 4K, the cushion ends 1164a, 1164b are each folded independently. In this method, the first cushion end 1164a is rolled toward the cushion throat 1162 oriented toward the windshield face 1166 of the airbag cushion 1160 to produce a first roll fold 1196a. Further, the second cushion end 1164b is also rolled toward the cushion throat 1162 oriented toward the windshield face 1166 of the airbag cushion 1160 to produce a second roll fold 1196b. This configuration is thus substantially opposite that shown in FIG. 4J, in which the roll folds 1096a, 1096b unroll toward the occupant face 1070 of the airbag cushion 1060.

As a result of the folding method of FIG. 4K, when the airbag cushion 1060 deploys, both cushion ends 1164a, 1164b unroll toward the windshield. As with the pattern shown in FIGS. 4H, 4I, and 4J above, this folding pattern having dual roll-folds 1196a, 1196b may be useful in larger airbag cushions 1160 in which a substantial bottom tuck fold is needed to shorten the cushion 1160.

Referring next to FIG. 4L, an airbag module 1210 is shown. The module 1210 has a module housing 40, an inflator 58, and an airbag cushion 1260 folded according to a method and pattern of the invention. The airbag cushion 1260 includes a cushion throat 1262, a windshield face 1266, an occupant face 1270, and first and second cushion ends 1264a, 1264b. The cushion 1260 was initially folded and prepared as discussed and illustrated above in connection with FIGS. 2A through 2C. In this method, the cushion 1260 underwent the tucking step shown in FIG. 2B to such an extent that two cushion ends 1264a, 1264b were produced. In the folding method and pattern illustrated in FIG. 4L, the cushion ends 1264a, 1264b are each folded independently. In this method, the first cushion end 1264a is accordion-folded toward the cushion throat 1262 to produce an accordion fold 1298. The second cushion end 1264b is rolled toward the cushion throat 1262 oriented toward the windshield face 1266 of the airbag cushion 1260 to produce a roll fold 1296.

As a result of this folding method, when the airbag cushion 1260 deploys, the first cushion end 1264a may expand rapidly toward the vehicle occupant, while the second cushion end 1264b may unroll toward the windshield. As with the patterns shown in FIGS. 4H-4K above, this folding pattern having a roll-fold 1296, and an accordion-fold 1298 may be useful in larger airbag cushions 1260 in which a substantial bottom tuck fold is needed to shorten the cushion 1260. Such a folding pattern may provide differential rates of deployment of the first cushion end 1264a and the second cushion end 1264b.

Referring next to FIG. 4M, an airbag module 1310 is shown. The module 1310 has a module housing 40, an inflator 58, and an airbag cushion 1360 folded according to a method and pattern of the invention. The airbag cushion 1360 includes a cushion throat 1362, a windshield face 1366, an occupant face 1370, and first and second cushion ends 1364a, 1364b. The cushion 1360 was initially folded and prepared as discussed and illustrated above in connection with FIGS. 2A through 2C. As in FIGS. 4G-4L above, the cushion 1360 underwent the tucking step shown in FIG. 2B to such an extent that two cushion ends 1364a, 1364b were produced. In the folding method and pattern illustrated in FIG. 4M, the cushion ends 1364a, 1364b are each folded independently. This method produces folds identical to those illustrated in FIG. 4L, with the exception that the roll fold 1396 is oriented to unroll toward the vehicle occupant while the roll fold 1296 of FIG. 4L is oriented to unroll toward the windshield. In the method illustrated in FIG. 4M, the first cushion end 1364a is accordion-folded toward the cushion throat 1362 to produce an accordion fold 1398. The second cushion end 1364b is rolled toward the cushion throat 1362 oriented toward the occupant face 1370 of the airbag cushion 1360 to produce a roll fold 1396.

As a result of this folding method, when the airbag cushion 1360 deploys, the first cushion end 1364a may expand rapidly toward the vehicle occupant, while the second cushion end 1364b may unroll toward the vehicle occupant. As with the patterns shown in FIGS. 4H-4L above, this folding pattern having a roll-fold 1396, and an accordion-fold 1398 may be useful in larger airbag cushions 1360 in which a substantial bottom tuck fold is needed to shorten the cushion 1360. Such a folding pattern may provide differential rates of deployment of the first cushion end 1364a and the second cushion end 1364b.

Referring next to FIG. 4N, an airbag module 1410 is shown. The module 1410 has a module housing 40, an inflator 58, and an airbag cushion 1460 folded according to a method and pattern of the invention. The airbag cushion 1460 includes a cushion throat 1462, a windshield face 1466, an occupant face 1470, and first and second cushion ends 1464a, 1464b. The cushion 1460 was initially folded and prepared as discussed and illustrated above in connection with FIGS. 2A through 2C. As in FIGS. 4G-4M above, the cushion 1460 underwent the tucking step shown in FIG. 2B to such an extent that two cushion ends 1464a, 1464b were produced. In the folding method and pattern illustrated in FIG. 4N, the cushion ends 1464a, 1464b are each folded independently. In the method illustrated in FIG. 4N, the first cushion end 1464a is rolled toward the cushion throat 1462 to produce a roll-fold 1496. The second cushion end 1464b is accordion folded toward the cushion throat 1462 oriented toward the occupant face 1470 of the airbag cushion 1460 to produce an accordion fold 1498.

As a result of this folding method, when the airbag cushion 1460 deploys, the first cushion end 1464a may unroll rapidly toward the vehicle occupant, while the second cushion end 1464b may expand outward and downward along the windshield. As with the patterns shown in FIGS. 4H-4M above, this folding pattern having a roll-fold 1496, and an accordion-fold 1498 may be useful in larger airbag cushions 1460 in which a substantial bottom tuck fold is needed to shorten the cushion 1460. Such a folding pattern may provide differential rates of deployment of the first cushion end 1464a and the second cushion end 1464b.

Referring next to FIG. 4O, an airbag module 1510 is shown. The module 1510 has a module housing 40, an inflator 58, and an airbag cushion 1560 folded according to a method and pattern of the invention. The airbag cushion 1560 includes a cushion throat 1562, a windshield face 1566, an occupant face 1570, and first and second cushion ends 1564a, 1564b. The cushion 1560 was initially folded and prepared as discussed and illustrated above in connection with FIGS. 2A through 2C. As in FIGS. 4G-4N above, the cushion 1560 underwent the tucking step shown in FIG. 2B to such an extent that two cushion ends 1564a, 1564b were produced. In the folding method and pattern illustrated in FIG. 4O, the cushion ends 1564a, 1564b are each folded independently. This method produces folds identical to those illustrated in FIG. 4N, with the exception that the roll fold 1596 is oriented to unroll toward the windshield while the roll fold 1496 of FIG. 4N is oriented to unroll toward the vehicle occupant. In the method illustrated in FIG. 4O, the first cushion end 1564a is rolled toward the cushion throat 1562 to produce a roll-fold 1596 oriented toward the windshield face 1566 of the airbag cushion 1506. The second cushion end 1564b is accordion folded toward the cushion throat 1562 of the airbag cushion 1560 to produce an accordion fold 1598.

As a result of this folding method, when the airbag cushion 1560 deploys, the first cushion end 1564a may expand rapidly toward the vehicle windshield, while the second cushion end 1564b may deploy along the windshield. As with the patterns shown in FIGS. 4H-4N above, this folding pattern having a roll-fold 1596, and an accordion-fold 1598 may be useful in larger airbag cushions 1560 in which a substantial bottom tuck fold is needed to shorten the cushion 1560. Such a folding pattern may provide differential rates of deployment of the first cushion end 1564a and the second cushion end 1564b.

Referring next to FIG. 4P, an airbag module 1610 is shown. The module 1610 has a module housing 40, an inflator 58, and an airbag cushion 1660 folded according to a method and pattern of the invention. The airbag cushion 1660 includes a cushion throat 1662, a windshield face 1666, an occupant face 1670, and first and second cushion ends 1664a, 1664b. The cushion 1660 was initially folded and prepared as discussed and illustrated above in connection with FIGS. 2A through 2C. As in FIGS. 4G-4O above, the cushion 1660 underwent the tucking step shown in FIG. 2B to such an extent that two cushion ends 1664a, 1664b were produced. In the folding method and pattern illustrated in FIG. 4P, the cushion ends 1664a, 1664b are each folded independently. In the method illustrated in FIG. 4P, the first and second cushion ends 1664a and 1664b are accordion folded toward the cushion throat 1662 of the airbag cushion 1660 to produce first and second accordion folds 1698a, 1698b.

As a result of this folding method, when the airbag cushion 1660 deploys, the cushion ends 1664a, 1664b both inflate rapidly and directly into position without having to unroll. As with the patterns shown in FIGS. 4H-4O above, this folding pattern having dual accordion-folds 1698a, 1698b may be useful in larger airbag cushions 1660 in which a substantial bottom tuck fold is needed to shorten the cushion 1660. Such a folding pattern may provide similar or identical rates of deployment of the first cushion end 1664a and the second cushion end 1664b.

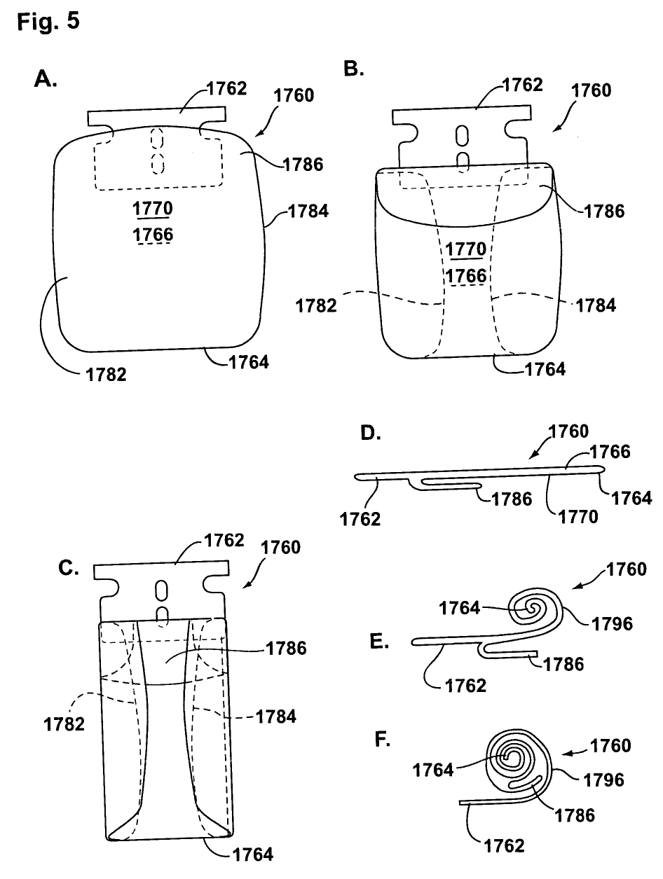

Referring next to FIGS. 5A-5F, the steps of another exemplary method of folding an airbag cushion according to the folding patterns of the invention are shown. This method may be especially useful with airbag cushions such as airbag cushion 1760 of FIG. 5 which includes a head region 1786. The airbag cushion 1760 further includes an cushion throat 1762 shown oriented at the top of FIG. 5A, and a cushion end 1764 is shown at the bottom of FIG. 5A.

FIG. 5A illustrates a first step in the folding methods of the invention in which the airbag cushion 1760 is shown with the windshield face 1766 and the occupant face 1770 flattened, the occupant face 1770 facing outward. According to folding methods of the invention, the airbag cushion 1760 may next either proceed to the folding steps illustrated in FIGS. 5B through 5F, or it may undergo an intermediate step illustrated in FIG. 2B in which an analogous cushion 60 is tuck-folded from the cushion end 64 inwardly toward the cushion throat 62. In some cases, the bottom tuck-folding step is useful where the airbag cushion 60 is large or long. In some variations of the folding methods of the invention, a bottom tuck-folding step may be repeated multiple times. Referring again to FIG. 5A, such bottom tuck-folds may produce multiple sets of lateral edges such as inboard and outboard edges 1782, 1784 shown in FIG. 5A.

Referring next to FIG. 5B, a next step of this folding method of the invention is shown in which the inboard and outboard edges 1782, 1784 of the airbag cushion 1760 are tucked inwardly, reducing the width of the airbag cushion 1760. In circumstances such as those discussed above in which multiple lateral edges are produced, the steps shown in FIG. 5B may be repeated as necessary. Such inward tucking may be useful when the width of the folded airbag 1760 must be adjusted to fit the space available for an airbag module 1760 in a particular vehicle. One of skill in the art would understand that the folding patterns of the invention may be easily adapted to accommodate other airbag cushions in which tuck-folding is unnecessary.

FIG. 5B also shows that the inboard 1782 and outboard 1784 edges of the airbag cushion 1760 are tucked inwardly. Following this tuck-folding step, the head region 1786 of the airbag cushion 1760 is folded downwardly toward the occupant face 1770 of the airbag cushion 1760. FIG. 5C shows a next step in which the airbag cushion 1760 may be further narrowed if needed by folding the edges produced by tuck-folding the inboard and outboard edges 1782, 1784 inwardly. This step may be omitted if the cushion has been narrowed sufficiently by the previous folding steps to achieve a size needed for an inflator housing.

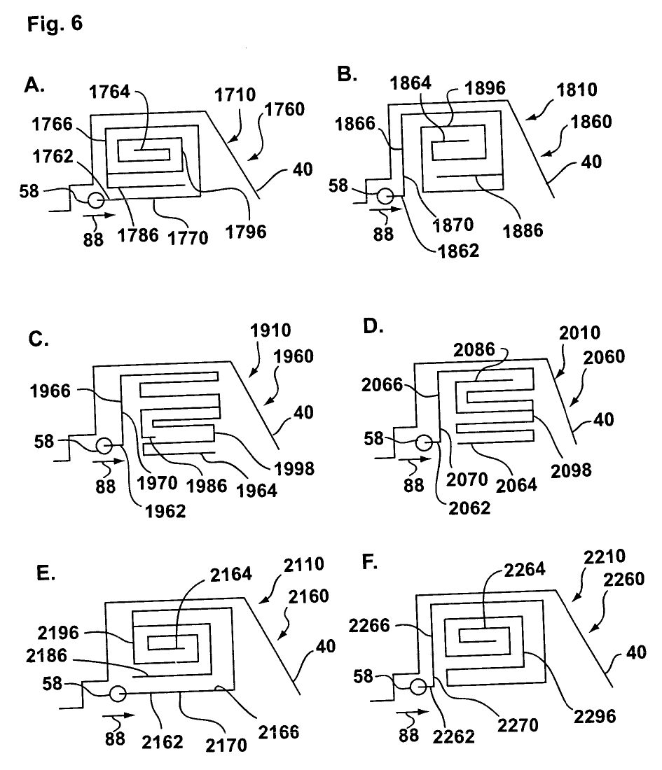

FIGS. 5D through 5F show an example of a set of secondary steps of folding methods and patterns of the invention useful with airbag cushions such as 1760 having head regions 1786. These secondary steps all generally condense the elongated narrow form produced by the initial folding steps shown in FIGS. 5A-5C to render the airbag cushion 1760 suitable for placement in an airbag module such as 1710 of FIG. 6A. In addition the types, order, proportions, and other characteristics of various folds used in these secondary steps may affect the trajectory of the airbag cushion 1760 during deployment.

Referring next to FIG. 5D, a side view of the partially-folded airbag cushion 1760 of FIGS. 5A-5C is shown. In FIG. 5D, the windshield face 1766 of the airbag cushion 1760 is oriented toward the top of FIG. 5D, and the occupant face 1770 is oriented toward the bottom of FIG. 5D. This additionally orients the head portion 1786 toward the bottom of the Figure. In FIG. 5E, the airbag cushion 1760 of FIG. 5D has been partially rolled from the cushion end 1764 toward the airbag mounting panel 1762. FIG. 5F is a side plan view of the folded and completely roll-folded airbag cushion 1760 of FIG. 5E. The cushion 1760 has been rolled toward the windshield face 1766 of the airbag cushion 1760. The roll-fold 1796 produced includes the head region 1786 of the airbag cushion 1760. It should be noted that the size of the roll-folded portion 1796 of the cushion 1760 may be varied within the scope of the invention to help control the deployment trajectory of the cushion 1760. In addition, the orientation of the roll fold 1796 (i.e., toward the windshield face 1766 of the cushion 1760 or toward the occupant face 1770 of the cushion 1760) may be varied within the scope of the invention.

Having been roll-folded, the airbag cushion 1760 is prepared to be mounted in an airbag module housing. Referring to FIG. 6A, an airbag module 1710 is shown which includes the rolled airbag cushion 1760. The module 1710 has a module housing 40, an inflator 58, and an airbag cushion 1760 folded as demonstrated in FIGS. 5A through 5F. The airbag cushion 1760 includes a cushion throat 1762, a windshield face 1766, an occupant face 1770, and a cushion end 1764. The airbag cushion 1760 is rolled from the cushion end 1764 toward the head region 1786 of the cushion 1760, with the roll fold 1796 produced being oriented toward the windshield face 1766 of the cushion 1760. As a result of this folding method, when the airbag cushion 1760 deploys, unrolling toward the windshield, the roll-fold 1796 rapidly places the head region 1786 of the airbag cushion in place and then places the remainder of the body of the airbag cushion 1760 into position.

Referring next to FIG. 6B, an alternative folding method of the invention is shown embodied in an airbag module 1810 including a cushion 1860 folded according to a pattern similar to that shown in FIGS. 5A through 5F. The module 1810 has a module housing 40, an inflator 58, and the airbag cushion 1860. The airbag cushion 1860 includes a cushion throat 1862, a windshield face 1866, an occupant face 1870, and a cushion end 1864. The airbag cushion 1860 is first folded as shown in FIGS. 5A through 5C, but is then rolled from the cushion end 1864 toward the cushion throat 1862 with the roll-fold 1896 produced being oriented toward the occupant face 1870 of the airbag cushion 1860. As a result of this folding method, when the airbag cushion 1860 deploys, the roll-fold 1896 rapidly unrolls toward the vehicle occupant, thus placing the head region 1886 of the airbag cushion in place and then placing the remainder of the body of the airbag cushion 1860 into position.

Referring next to FIG. 6C, an alternative folding method of the invention is shown embodied in an airbag module 1910 including a cushion 1960 folded according to a method of the invention. The module 1910 has a module housing 40, an inflator 58, and the airbag cushion 1960. The airbag cushion 1960 includes a cushion throat 1962, a windshield face 1966, an occupant face 1970, and a cushion end 1964. The airbag cushion 1960 is first folded as shown in FIGS. 5A through 5C. Following this, however, the cushion 1960 is accordion-folded from the cushion end 1964 toward the cushion throat 1962. As the cushion 1960 is accordion-folded, the head region 1986 of the cushion 1960 is simply accordion-folded along with the rest of the cushion 1960, as shown in FIG. 6C. The accordion-fold 1998 produced allows rapid deployment of the airbag cushion 1960 outward and downward along the windshield of a vehicle.

FIG. 6D shows yet another alternative folding method of the invention embodied in an airbag module 2010 having a cushion 2060 folded according to a method of the invention. The module 2010 has a module housing 40, an inflator 58, and the airbag cushion 2060. The airbag cushion 2060 includes a cushion throat 2062, a windshield face 2066, an occupant face 2070, and a cushion end 2064. The airbag cushion 2060 is first folded as shown in FIGS. 5A and 5B. In contrast with many of the folding methods discussed previously, the head region 2086 of the cushion 2060 is not folded downward, but is allowed to remain flat. Following the folding steps shown in FIGS. 5A and 5B, the cushion 2060 is accordion-folded from the cushion end 2064 toward the head region 2086. As the cushion 2060 is accordion-folded, the head region 2086 of the cushion 2060 is accordion-folded with the last of the cushion 2060, as shown in FIG. 6D. The accordion fold 2098 produced allows rapid deployment of the cushion 2060.

Still another alternate folding method of the invention is illustrated in FIG. 6E. The airbag module 2110 of FIG. 6E has a module housing 40, an inflator 58, and an airbag cushion 2160. The airbag cushion 2160 includes a cushion throat 2162, a windshield face 2166, an occupant face 2170, and a cushion end 2164. The airbag cushion 2160 is first folded as shown in FIGS. 5A and 5B. As in the method illustrated in FIG. 6E, the head region 2186 is not folded downward, but is allowed to remain flat. Following the folding steps shown in FIGS. 5A and 5B, the cushion 2160 is rolled from the cushion end 2164 toward the head region 2186. In this method, the rolling is conducted oriented toward the windshield face 2166 of the cushion 2160 such that the roll-fold 2196 produced unrolls toward the windshield of the vehicle in which the module 2110 is installed. As the cushion 2160 is rolled, the roll fold 2196 formed is advanced up to the head region 2186. At this point, the head region 2186 is folded about the roll fold 2196, as shown in FIG. 6E.

Referring next to FIG. 6F, yet another folding method of the invention is shown embodied in an airbag module 2210 which includes an airbag cushion 2260 folded according to a method of the invention. The airbag cushion 2260 includes a cushion throat 2262, a windshield face 2266, and occupant face 2270, and a cushion end 2264. The airbag cushion 2260 is first folded as shown in FIGS. 2A through 2C. Following this, the cushion 2260 is rolled from the cushion end 2264 toward the cushion throat 2262. The cushion 2260 is partially rolled in a windshield-oriented fashion. Following this, the cushion is next rolled in an occupant-oriented fashion. This produces a roll-fold 2296 which, when deployed, first unrolls toward the vehicle occupant, and next unrolls toward the windshield. One of skill in the art would understand that the order of these rolls could be modified to allow the roll fold 2296 to first unroll toward the windshield, and next toward the vehicle occupant.

In summary, the present invention provides a family of folding methods and patterns for folding an airbag cushion. In some embodiments, the invention provides folding methods useful with overhead airbag cushions. These folding methods and patterns assist in controlling the trajectory of the airbag cushion during deployment. More specifically, the methods and patterns of the invention may allow an airbag cushion to be deployed forwardly and downward along a windshield to place a portion of the airbag cushion rapidly in front of a vehicle occupant before significantly inflating the cushion in a longitudinal direction to provide support and deceleration to a vehicle occupant.

The present invention may be embodied in other specific forms without departing from its structures, methods, or other essential characteristics as broadly described herein and claimed hereinafter. More specifically, one of skill in the art will understand that the order and magnitude of the roll-folds, accordion-folds and other folds produced may be modified to alter the deployment characteristics of the airbag cushion. Thus, the described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A method of folding an airbag cushion comprising the steps of:
providing an airbag cushion, the airbag cushion having a cushion throat, a windshield face, an occupant face, first and second lateral sides, and a cushion end;
flattening the windshield and occupant faces of the airbag cushion;
folding the first and second lateral sides of the airbag cushion inwardly; and
contraction folding the airbag cushion from the cushion end toward the cushion throat.

2. The method of claim 1, wherein the airbag cushion is an overhead airbag cushion.

3. The method of claim 1, wherein the step of folding the first and second lateral sides of the airbag inwardly comprises flattening them against a face of the airbag cushion.

4. The method of claim 3, wherein the step of folding the first and second lateral sides of the airbag inwardly comprises flattening them against the windshield face of the airbag cushion.

5. The method of claim 3, wherein the step of folding the first and second lateral sides of the airbag inwardly comprises flattening them against the occupant face of the airbag cushion.

6. The method of claim 3, wherein the step of folding the first and second lateral sides of the airbag inwardly produces an overlap.

7. The method of claim 3, wherein the step of contraction-folding the airbag cushion from the cushion end toward the cushion throat comprises rolling the airbag cushion from the cushion end toward the cushion throat.

8. The method of claim 7, wherein rolling the airbag cushion from the cushion end toward the cushion throat is conducted toward the windshield face of the airbag cushion.

9. The method of claim 7, wherein rolling the airbag cushion from the cushion end toward the cushion throat is conducted toward the occupant face of the airbag cushion.

10. The method of claim 3, wherein the step of contraction-folding the airbag cushion from the cushion end toward the cushion throat comprises accordion-folding the airbag cushion from the cushion end toward the cushion throat.

11. The method of claim 3, wherein the step of contraction-folding the airbag cushion from the cushion end toward the cushion throat comprises accordion-folding a portion of the airbag cushion from the cushion end toward the cushion throat and wrap-folding a remaining portion of the airbag cushion from the cushion end toward the cushion throat.

12. The method of claim 11, wherein wrap-folding a remaining portion of the airbag cushion from the cushion end toward the cushion throat is conducted toward the windshield face of the airbag cushion.

13. The method of claim 11, wherein wrap-folding a remaining portion of the airbag cushion from the cushion end toward the cushion throat is conducted toward the occupant face of the airbag cushion.

14. The method of claim 1, wherein the step of folding the first and second lateral sides of the airbag cushion inwardly comprises tucking the first and second lateral sides inwardly.

15. The method of claim 14, wherein the step of contraction-folding the airbag cushion from the cushion end toward the cushion throat comprises rolling the airbag cushion from the cushion end toward the cushion throat.

16. The method of claim 15, wherein rolling the airbag cushion from the cushion end toward the cushion throat is conducted toward the windshield face of the airbag cushion.

17. The method of claim 15, wherein rolling the airbag cushion from the cushion end toward the cushion throat is conducted toward the occupant face of the airbag cushion.

18. The method of claim 3, wherein the step of contraction-folding the airbag cushion from the cushion end toward the cushion throat comprises accordion-folding the airbag cushion from the cushion end toward the cushion throat.

19. The method of claim 3, wherein the step of contraction-folding the airbag cushion from the cushion end toward the cushion throat comprises accordion-folding a portion of the airbag cushion from the cushion end toward the cushion throat and wrap-folding a remaining portion of the airbag cushion from the cushion end toward the cushion throat.

20. The method of claim 19, wherein wrap-folding a remaining portion of the airbag cushion from the cushion end toward the cushion throat is conducted toward the windshield face of the airbag cushion.

21. The method of claim 19, wherein wrap-folding a remaining portion of the airbag cushion from the cushion end toward the cushion throat is conducted toward the occupant face of the airbag cushion.

22. The method of claim 1, wherein the airbag cushion further comprises a head region adjacent to the cushion throat.

23. The method of claim 22, wherein the step of folding the first and second lateral sides of the airbag cushion inwardly is preceded by a step of folding the head region of the airbag cushion inwardly.

24. The method of claim 23, wherein the step of folding the head portion of the airbag cushion inwardly comprises flattening the head region of the airbag cushion against the occupant face of the airbag cushion.

25. The method of claim 23, wherein the step of contraction folding the airbag cushion from the cushion end toward the cushion throat comprises rolling the airbag cushion from the cushion end toward the cushion throat.

26. The method of claim 25, wherein rolling the airbag cushion from the cushion end toward the cushion throat is conducted toward the windshield face of the airbag cushion.

27. The method of claim 25, wherein rolling the airbag cushion from the cushion end toward the cushion throat is conducted toward the occupant face of the airbag cushion.

28. The method of claim 23, wherein the step of contraction folding the airbag cushion from the cushion end toward the cushion throat comprises accordion-folding a portion of the airbag cushion from the cushion end toward the cushion throat.

29. The method of claim 22, wherein the step of contraction folding the airbag cushion from the cushion end toward the cushion throat is followed by folding the head region of the airbag cushion about the contraction-folded portion of the airbag cushion.

30. A method of folding an overhead airbag cushion comprising the steps of:
providing an overhead airbag cushion, the overhead airbag cushion having a cushion throat, a windshield face, an occupant face, first and second lateral sides, and a cushion end;
flattening the windshield and occupant faces of the airbag cushion;
folding the first and second lateral sides of the overhead airbag cushion inwardly against a face of the airbag cushion to narrow the airbag cushion to a desired width; and
contraction-folding the airbag cushion from the cushion end toward the cushion throat.

31. The method of claim 30, wherein the step of folding the first and second lateral sides of the airbag inwardly against a face of the airbag cushion comprises flattening them against the windshield face of the airbag cushion.

32. The method of claim 30, wherein the step of folding the first and second lateral sides of the airbag inwardly against a face of the airbag cushion comprises flattening them against the occupant face of the airbag cushion.

33. The method of claim 30, wherein the step of folding the first and second lateral sides of the airbag inwardly against a face of the airbag cushion produces an overlap.

34. The method of claim 30, wherein the step of contraction-folding the airbag cushion from the cushion end toward the cushion throat comprises rolling the airbag cushion from the cushion end toward the cushion throat.

35. The method of claim 34, wherein rolling the airbag cushion from the cushion end toward the cushion throat is conducted toward the windshield face of the airbag cushion.

36. The method of claim 34, wherein rolling the airbag cushion from the cushion end toward the cushion throat is conducted toward the occupant face of the airbag cushion.

37. The method of claim 30, wherein the step of contraction-folding the airbag cushion from the cushion end toward the cushion throat comprises accordion-folding the airbag cushion from the cushion end toward the cushion throat.

38. The method of claim 30, wherein the step of contraction-folding the airbag cushion from the cushion end toward the cushion throat comprises accordion-folding a portion of the airbag cushion from the cushion end toward the cushion throat and wrap-folding a remaining portion of the airbag cushion from the cushion end toward the cushion throat.

39. The method of claim 38, wherein wrap-folding a remaining portion of the airbag cushion from the cushion end toward the cushion throat is conducted toward the windshield face of the airbag cushion.

40. The method of claim 38, wherein wrap-folding a remaining portion of the airbag cushion from the cushion end toward the cushion throat is conducted toward the occupant face of the airbag cushion.

41. A method of folding an overhead airbag cushion comprising the steps of:
providing an overhead airbag cushion, the overhead airbag cushion having a cushion throat, a windshield face, an occupant face, first and second lateral sides, and a cushion end;
flattening the windshield and occupant faces of the airbag cushion;
tucking the first and second lateral sides of the overhead airbag cushion inwardly to narrow the airbag cushion to a desired width; and
contraction-folding the overhead airbag cushion from the cushion end toward the cushion throat.

42. The method of claim 41, wherein the step of contraction-folding the overhead airbag cushion from the cushion end toward the cushion throat comprises rolling the overhead airbag cushion from the cushion end toward the cushion throat.

43. The method of claim 42, wherein the step of rolling the overhead airbag cushion from the cushion end toward the cushion throat is conducted toward the windshield face of the overhead airbag cushion.

44. The method of claim 42, wherein the step of rolling the overhead airbag cushion from the cushion end toward the cushion throat is conducted toward the occupant face of the overhead airbag cushion.

45. The method of claim 41, wherein the step of contraction-folding the airbag cushion from the cushion end toward the cushion throat comprises accordion-folding the airbag cushion from the cushion end toward the cushion throat.

46. The method of claim 41, wherein the step of contraction-folding the airbag cushion from the cushion end toward the cushion throat comprises accordion-folding a portion of the airbag cushion from the cushion end toward the cushion throat and wrap-folding a remaining portion of the airbag cushion from the cushion end toward the cushion throat.

47. The method of claim 46, wherein wrap-folding a remaining portion of the airbag cushion from the cushion end toward the cushion throat is conducted toward the windshield face of the airbag cushion.

48. The method of claim 46, wherein wrap-folding a remaining portion of the airbag cushion from the cushion end toward the cushion throat is conducted toward the occupant face of the airbag cushion.

49. A method of folding an overhead airbag cushion comprising the steps of:
providing an overhead airbag cushion, the overhead airbag cushion having a cushion throat, a head region, a windshield face, an occupant face, first and second lateral sides, and a cushion end;
flattening the windshield and occupant faces of the airbag cushion;
folding the head region of the overhead airbag cushion inwardly;
folding the first and second lateral sides of the overhead airbag cushion inwardly against a face of the airbag cushion to narrow the airbag cushion to a desired width; and
contraction-folding the airbag cushion from the cushion end toward the cushion throat.

50. The method of claim 49, wherein the step of folding the head region of the overhead airbag cushion inwardly comprises flattening the head region of the overhead airbag cushion against the occupant face of the overhead airbag cushion.

51. The method of claim 49, wherein the step of folding the head region of the overhead airbag cushion inwardly comprises flattening the head region of the overhead airbag cushion against the windshield face of the overhead airbag cushion.

52. The method of claim 49, wherein the step of contraction-folding the airbag cushion from the cushion end toward the cushion throat comprises rolling the airbag cushion from the cushion end toward the cushion throat.

53. The method of claim 50, wherein rolling the airbag cushion from the cushion end toward the cushion throat is conducted toward the windshield face of the airbag cushion.

54. The method of claim 50, wherein rolling the airbag cushion from the cushion end toward the cushion throat is conducted toward the occupant face of the airbag cushion.

55. The method of claim 49, wherein the step of contraction-folding the airbag cushion from the cushion end toward the cushion throat comprises accordion-folding the airbag cushion from the cushion end toward the cushion throat.

56. The method of claim 49, wherein the step of contraction-folding the airbag cushion from the cushion end toward the cushion throat comprises accordion-folding a portion of the airbag cushion from the cushion end toward the cushion throat and wrap-folding a remaining portion of the airbag cushion from the cushion end toward the cushion throat.

57. The method of claim 56, wherein wrap-folding a remaining portion of the airbag cushion from the cushion end toward the cushion throat is conducted toward the windshield face of the airbag cushion.

58. The method of claim 56, wherein wrap-folding a remaining portion of the airbag cushion from the cushion end toward the cushion throat is conducted toward the occupant face of the airbag cushion.

59. A method of folding an overhead airbag cushion comprising the steps of:
providing an overhead airbag cushion, the overhead airbag cushion having a cushion throat, a head region, a windshield face, an occupant face, first and second lateral sides, and a cushion end;
folding the head region of the overhead airbag cushion inwardly;
flattening the windshield and occupant faces of the airbag cushion;
tucking the first and second lateral sides of the overhead airbag cushion inwardly to narrow the airbag cushion to a desired width; and
contraction-folding the airbag cushion from the cushion end toward the cushion throat.

60. The method of claim 59, wherein the step of folding the head region of the overhead airbag cushion inwardly comprises flattening the head region of the overhead airbag cushion against the occupant face of the overhead airbag cushion.

61. The method of claim 59, wherein the step of folding the head region of the overhead airbag cushion inwardly comprises flattening the head region of the overhead airbag cushion against the windshield face of the overhead airbag cushion.

62. The method of claim 59, wherein the step of contraction-folding the airbag cushion from the cushion end toward the cushion throat comprises rolling the airbag cushion from the cushion end toward the cushion throat.

63. The method of claim 62, wherein rolling the airbag cushion from the cushion end toward the cushion throat is conducted toward the windshield face of the airbag cushion.

64. The method of claim 62, wherein rolling the airbag cushion from the cushion end toward the cushion throat is conducted toward the occupant face of the airbag cushion.

65. The method of claim 59, wherein the step of contraction-folding the airbag cushion from the cushion end toward the cushion throat comprises accordion-folding the airbag cushion from the cushion end toward the cushion throat.

66. The method of claim 59, wherein the step of contraction-folding the airbag cushion from the cushion end toward the cushion throat comprises accordion-folding a portion of the airbag cushion from the cushion end toward the cushion throat and wrap-folding a remaining portion of the airbag cushion from the cushion end toward the cushion throat.

67. The method of claim 66, wherein wrap-folding a remaining portion of the airbag cushion from the cushion end toward the cushion throat is conducted toward the windshield face of the airbag cushion.

68. The method of claim 66, wherein wrap-folding a remaining portion of the airbag cushion from the cushion end toward the cushion throat is conducted toward the occupant face of the airbag cushion.
